(19) United States
(12) Patent Application Publication
(10) Pub. No.: US 2007/0166503 A1
(43) Pub. Date: Jul. 19, 2007

(54) Multifunctional composite vapor barrier textile

(76) Inventor: Ryan B. Hannigan, West Hartford, CT (US)

Correspondence Address: MCCARTER & ENGLISH LLP;CITYPLACE I, 185 ASYLUM STREET, HARTFORD, CT, 06103, US

(21) Appl. No.: 11/642,120

(22) Filed: Dec. 20, 2006

Related U.S. Application Data
(60) Provisional application No. 60/752,245, filed on Dec. 20, 2005.

(51) Int. Cl. B32B 3/00; B32B 3/02

(52) U.S. Cl. 428/59; 428/86; 428/62

(57) ABSTRACT

The present invention is directed to a multifunctional waterproof/vapor barrier fabric for use in industrial, medical, outdoor apparel (hunting, fishing, skiing, mountaineering, etc.) and military applications. The invention combines functional elements that are especially suited for the above applications. The fabric comprises a lining with wicking and antimicrobial properties, a vapor barrier film or coating with low Moisture Vapor Transmission Rate (M.V.T.R.), and a woven or knit face fabric enhanced with a hydrophobic face coating. The fabric performs admirably in various uses due in part to the use of hydrophobic adhesive, film and coatings, which renders the fabric subject to negligible moisture gain. The durability and water proof properties of the fabric are enhanced due to the impermeable low M.V.T.R design. The fabric of the present invention incorporates a unique combination of properties that addresses issues commonly associated with vapor barrier fabrics. The invention provides a waterproof/barrier fabric that is desirable to wear in direct contact with the skin to prevent evaporative heat loss in cool or cold conditions. The fabric is also effective when worn over one or more layers of other clothing. The fabric is particularly effective because it is capable of use as a base layer and waterproof shell, which helps to minimize the number of layers of clothing needed in cold weather.

### CROSS-REFERENCE TO RELATED APPLICATIONS

This application claims priority to U.S. Provisional Patent Application No. 60/752,245, filed Dec. 20, 2005, which is hereby expressly incorporated by reference as part of the present disclosure.

### BACKGROUND OF THE INVENTION

It has been the trend in the past several decades to develop breathable textile and clothing systems which allow for the diffusion or evaporation of moisture or vapor. Numerous types of breathable textiles can be found, such as, for example, the fabrics described in U.S. Pat. No. 4,194,041 to Gore, U.S. Pat. No. 5,026,591 to Henn, and U.S. Pat. No. 5,660,198 to McClaran, and U.S. Pat. No. 4,761,324 to Rautenberg. It is widely accepted by those skilled in the art, as well as the consuming public, that a multilayer system is desirable for protection against cold temperatures. Cold weather layering systems are typically comprised of various porous insulating layers, such as for example fleece garments, with protection from the elements being provided by the outer shell fabric. The current cold weather layering system for the military (ECWCS) is comprised of 5 layers with only the outermost layer being waterproof.

It is current practice to develop and utilize breathable waterproof fabrics which seek to allow the diffusion and evaporation of internal moisture through the fabrics. Among the disadvantages of these breathable fabrics is that the diffusion of moisture through the fabric and subsequent evaporation of that moisture is inherently slow. In addition, breathable systems are subject to condensation and potential ice build-up caused by moisture diffusing through the system. As dead air space is replaced by moisture, the insulating capability of the layers is diminished creating unwanted conductive and evaporative cooling.

The present invention breaks from this traditional practice. It has been found that multi-layer breathable systems tend to promote overdressing. The present invention is based on research which reveals that the most effective means for regulating one's temperature is to either prevent or permit evaporative heat loss directly from the skin's surface, as opposed to the very slow diffusion and evaporation inherent in breathable systems. Moisture that is evaporated from the skin has been found to condense at the dew point of the temperature gradient inside the clothing system. Because water has a high heat capacity it has been found that it is preferable to retain moisture closest to the heat source (human body) as opposed to letting it diffuse outward towards the colder outside environment.

U.S. Pat. No. 6,319,864 to Hannigan describes a triple laminate vapor barrier fabric with a thin lining, a barrier layer and an outer insulation layer (fleece or fiberfill). It has been discovered that use of this fabric in base layer garments requires an additional layer to protect the insulation layer from external moisture. The thickness of the insulation, combined with the need for a waterproof layer to protect the insulation, creates a situation where the user may be overdressed for optimum control of body temperature. Moreover, the fabric described in U.S. Pat. No. 6,319,864 does not incorporate the important moisture wicking and antimicrobial properties that the fabric of the present invention provides.

The present invention departs from the prior art of breathable textiles and solves the condensation problems inherent in them. The present invention is based on the discovery that, in cold climates, it is most efficient to control a person's temperature by creating a microclimate immediately adjacent to the skin by using a vapor barrier. Although vapor barrier clothing is commercially available, it is constructed of simple coated or laminated fabrics which lack the special design elements set forth in the fabric of the present invention. Existing vapor barrier fabrics and garments lack the features set forth in the fabric of the invention, which is the primary reason why these fabrics and garments have not been readily accepted. Available vapor barrier fabrics lack the combination of durability (exposed film subject to abrasion), hydrophobic outer layer (exposed insulation), and multi-functional lining fabric (wicking/antimicrobial/textured). The failure to integrate multifunctional (wicking/antimicrobial/textured) fibers into the lining fabric of vapor barrier fabrics has prevented the vapor barrier layering principle from gaining wide-spread acceptance. Among the disadvantages of the prior vapor barrier fabrics are overheating (sweat build-up) and odor.

The fabric of the present invention is best used next to the skin or in close proximity to the skin, because the wearer will be able to sense moisture build-up from perspiration caused by overheating. Instead of expecting the fabric to diffuse the internal moisture through the system, the wearer can simply adjust insulation and/or vent to cool down and relieve the overheating. It should also be appreciated that the fabric of the present invention functions admirably as a waterproof shell over any given number of layers.

A wide variety of coatings and films are available which are generally regarded as non-breathable. These films and coatings are widely used in rainwear. Non-breathable foul weather wear is typically available at lower costs because the consumer has come to accept breathable designs as the higher-performance alternative. It is also recognized that rainwear (both breathable and non-breathable) often incorporate a lining (e.g. taffeta, tricot, mesh). These linings can be either a separate drop lining or laminated to the inside of the fabric. It is commonly accepted by those skilled in the art that the purpose of this lining is to protect the coating or film from abrasion and to add to the comfort and aesthetic properties of the garment.

The current common practice of cold weather layering does not embrace the use of a waterproof layer in direct contact with the skin. The lining of fabrics of waterproof garments (breathable or non-breathable) generally lack one or more of the three specific properties listed below:
1—High moisture wicking rate
2—Durable antimicrobial properties (AATCC)
3—Texture (brushed, sueding/sanding, incorporation of spun yarn)

While there are a several fibers available with wicking and antimicrobial properties, the multi-layer breathable systems have typically incorporated these properties into separate knit-base layer garments (i.e. thermal underwear). Prior fabrics placed emphasis on moisture management fibers which promoted moving moisture through the various layers toward the outer layer. However, the fabric of the present invention uses wicking (moisture management) fibers is to rapidly disperse moisture across the surface of the lining fabric preventing pooling of perspiration and accelerating drying time. It should be appreciated that the most effective fibers are those which function based on capillary action vs. topical wicking treatments. As to antimicrobial properties, it is also desirable for the fibers to be treated throughout the fiber as opposed to surface treatments.

Accordingly, it is an objective of the fabric of the present invention address these and other disadvantages of prior fabrics. Among the advantages of the fabric of the present invention are that the fabric (1) prevents evaporative heat loss, (2) provides comfort (wicking/textured fiber), (3) provides safety (incorporation of durable antimicrobial fibers), and (4) provide a durable waterproof fabric. Other advantages of the fabric of the present invention will be readily apparent on those skilled in the art based upon the detailed description of preferred embodiments set forth below.

### DESCRIPTION OF THE DRAWING OF THE INVENTION

FIG. 1 shows a schematic of the fabric of the present invention.

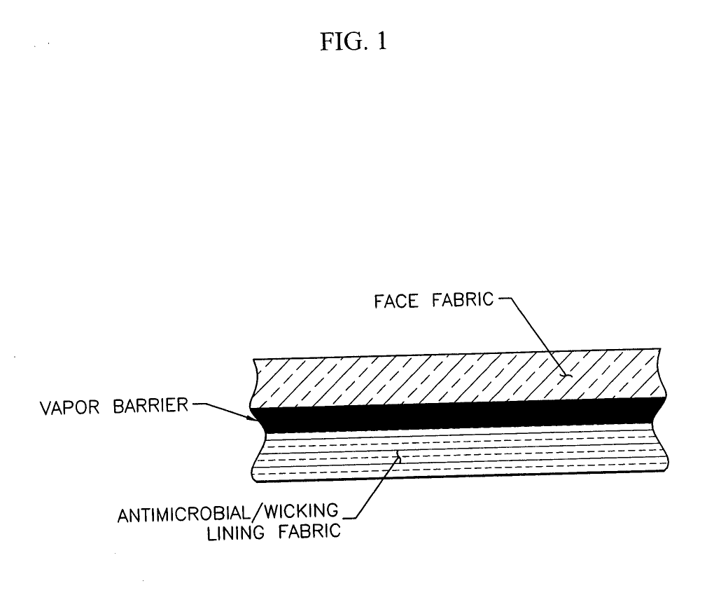

### DESCRIPTION OF PREFERRED EMBODIMENTS

The fabric of the present invention solves problems never before addressed by either breathable or non-breathable waterproof textile designs. Among the objectives of this invention is to block evaporative heat loss by creating a microclimate with higher humidity adjacent to the skin of the wearer, to provide safety by using antimicrobial fibers, to provide comfort by using wicking fiber and to provide a durable waterproof fabric.

The fabric of the present invention comprises (1) a lining material having good wicking of moisture and antimicrobial properties, (2) a vapor barrier film or coating with a low Moisture Vapor Transmission Rate (MVTR), and (3) a woven or knit face fabric. The face fabric may be enhanced with a hydrophobic face coating. In a preferred embodiment, the finished layered fabric has a hydrostatic resistance of at least 70 lbs as measured by ASTM D-751 Method B (Suter).

The lining material may be any appropriate material having a sufficient moisture wicking properties to move moisture such as perspiration from the skin. For example, a circular knit lining, such as jersey, interlock, pique or crepe. Alternatively, the lining may be a warp knit lining, such as tricot or raschel. The lining fiber preferably includes between 10-100% antimicrobial fiber (most preferable those synthetic fibers containing cupric oxide), spun polyester yarn to enhance tactile feel, and at least 30% moisture managing (wicking) fibers (spun or filament) which function through capillary action (high filament count). Such suitable fibers are sold under the following names Coolmax (Invista), SorbTek (Unifi) and DriRelease (a spun yarn by Optimer). Suitable fabrics have been knitted from these fibers by Niche Fabrics, Cleveland Tenn.

The lining material is preferably laminated to the barrier layer through a coating method or by use of an adhesive. Lamination may be performed using continuous or discontinuous lamination methods known to those skilled in the art. Examples of lamination or coating methods that may be used include rotogravure, knife over roll, floating knife, knife over gap, knife over bed, hot melt (web, powder, film, spray, die/slot). The invention is not limited in this regard, however, and the lining may be be attached to the barrier layer/face fabric by any other means, such as for example by sewing.

The fabric of the present invention include a barrier layer. The barrier layer may comprise any polymeric coating or film, such as for example polyether or polyester urethane compounds, which exhibit low moisture transmission levels, are hydrophobic, and which are not generally regarded as being breathable (hydrophilic or micorporous or bicomponent). Suppliers of known suitable coatings include Bayer, Raffi & Swanson, Soluol Chemical. Suitable films are supplied by Argotec/Omniflex, and Deerfield Urethanes. In a preferred embodiment, the barrier film or coating is a polyurethane film which enables thermoforming and bonding abilities in the construction of the end garment (i.e. seam taping or welding). Preferably, the barrier film or coating is provided in a thickness of between about 0.1 mils to about 3 mils (0.10-3.0 oz per sq yd). The desired properties of this film are a moisture vapor transmission lower than 500 gm/m2/24 hr as measured by ASTM E-96 Procedure B. In a preferred embodiment, the M.V.T.R. is less than 400 gm/m2/24 hr. If desired, the barrier film may be a flame retardant material, such as, for example, a halogenated urethane compound.

Methods of producing a barrier layer (impermeable or breathable) on a fabric include through a polymer coating generally applied with one of the various knife coating techniques: knife over roll, floating knife, reverse roll. It should be appreciated that the methods for applying a barrier film and/or coatings are known to those skilled in the art in the textile industry and any appropriate method known to those skilled in the art may be used for applying the film and/or coating.

Vapor barrier (non breathable) textiles are commonly associated with having a propensity for retaining odors. There are a number of variables (adhesive, coating/film compounds, cure temperature) which can affect a fabric's ability to retain odors. It has been discovered that by using hydrophobic adhesive, coating or film compounds, the amount of moisture absorption/transmission into and through the coated or laminated fabric is minimized. The adhesive application technique may by custom made rotary screen with use of liquid adhesive or via a rotary screen application of hot melt thermoplasic/thermoset adhesive.

The barrier layer structure of this invention creates a microclimate adjacent to the skin of the wearer with higher potential humidity. The barrier construction with low M.V.T.R also serves to block the bacterial breeding ground since internal moisture containing microbes is prevented from entering fabric/garment layers outside of the barrier which would otherwise occur in breathable textile designs. Antimicrobial fibers in the lining fabric, such as those containing cupric oxide, function through ion activity which disrupts the cell walls of the microbe. The invention is not limited in this regard, and any antimicrobial fiber treatment known to those skilled in the art can be used. The ion activity requires moisture to function. Fibers containing as low as 1% cupric oxide have been tested to be both biostatic and biocidal. Therefore, containment of moisture and microorganisms within the barrier layer greatly increases the efficacy of the antimicrobial properties.

The face fabric may be any woven, knit, or non-woven fabric and will generally weigh in the range of 0.5-9 oz per sq yd. The invention is not limited in this regard, and any appropriate face fabric may be used. The purpose of the face fabric is to provide required durability (tear and abrasion resistance) while exhibiting the required hand for the intended application. The face fabrics most typically will be a woven or warp-knitted fabric but may include circular knit (i.e. interlock) varieties such as those of interlock construction which exhibits sufficient durability for use as an outer layer. Preferred fabrics include nylon or polyester ripstops, tricots or interlock knits. The invention is not limited in this regard, and any appropriate fabric may be used. A silicon or fluorochemical finish may be provided on the surface.

If desired, the lining and face fabrics may be constructed from any appropriate flame retardant materials such as, for example, para-aramids (Nomex) or meta-aramids (Kevlar, PBO, BPI or Basofil).

### EXAMPLE

An example of a fabric of the present invention and a brief description of the process for making the fabric is provided. A 30 Demier nylon fabric to be used as the face fabric is first either coated with a hydrophobic surface coating, such as a polyurethane polymer, or is laminated to a barrier film, such as, for example, a polyurethane, olefin, or polyethylene barrier film. The hydrophobic surface coating is applied to the face fabric on the side of the fabric opposite the barrier film. The penetrating surface coating is preferably a cross-linking fluorochemical or a silicone polymer. After the face fabric has been coated with the hydrophobic surface coating and laminated to the barrier film, the lining fabric is applied to the barrier film or coating.

Alternatively, the lining fabric could be laminated to the barrier film prior to the face fabric being treated with the hydrophobic top coat.

1. A fabric comprising a lining, a barrier layer, and a face fabric with a hydrophobic surface coating.

2. The fabric of claim 1, wherein the lining is attached to the barrier layer with an adhesive.

3. The fabric of claim 1, wherein the lining is attached to the barrier layer by sewing.

4. The fabric of claim 1, wherein the barrier coating or film is olefin based.

5. The fabric of claim 1, wherein the barrier coating or film is polyethylene, nylon, polyester, or polytetrafluoraethylene

6. The fabric of claim 1, wherein at least one of the lining, face fabrics and barrier film are constructed from flame retardant materials.

7. The fabric of claim 6, wherein the flame retardant material are selected from the group consisting of para-aramids and meta-aramids.

8. The fabric of claim 1, wherein the barrier film is a halogenated urethane compound).

9. The fabric of claim 1, wherein the finished layered fabric has hydrostatic resistance of at least 70 lbs as measured by ASTM D-751 Method B (Suter).

10. The fabric of claim 1, wherein the barrier layer has an M.V.T.R of <400 gm/m2/24 hr as measured by ASTM E96B (upright cup 73 F/50% R.H).

11. The fabric of claim 1, wherein the lining and barrier layer are laminated by one of rotogravure, knife over roll, floating knife, knife over gap, knife over bed, or hot melt.

12. The fabric of claim 1, wherein the lamination of the lining and the barrier layer is performed by one of continuous or discontinuous lamination.
